(19) United States
(12) Patent Application Publication
(10) Pub. No.: US 2026/0154062 A1
(43) Pub. Date: Jun. 4, 2026

(54) SOFTWARE UPDATING SYSTEM, SOFTWARE UPDATING DEVICE, SOFTWARE UPDATING METHOD, AND STORAGE MEDIUM

(71) Applicant: HONDA MOTOR CO., LTD., TOKYO (JP)

(72) Inventor: Yasumasa KAITANI, TOKYO (JP)

(21) Appl. No.: 19/403,823

(22) Filed: Nov. 29, 2025

(30) Foreign Application Priority Data
Dec. 4, 2024 (JP) 2024-210839

(51) Int. Cl. G06F 8/65

(52) U.S. Cl. CPC G06F 8/65

(57) ABSTRACT

In the case that a vehicle is equipped with a shift-by-wire system configured to automatically shift a shift position to a parking position, at a time when a first predetermined condition is satisfied, a software updating system carries out a confirmation process to confirm with a user whether or not to approve the execution of a software updating process with respect to an electronic control unit that is provided in the vehicle, and in the case that the vehicle is not equipped with the shift-by-wire system, carries out the confirmation process at a time when a second predetermined condition that differs from the first predetermined condition is satisfied.

### CROSS-REFERENCE TO RELATED APPLICATIONS

This application is based upon and claims the benefit of priority from Japanese Patent Application No. 2024-210839 filed on Dec. 4, 2024, the contents of which are incorporated herein by reference.

### BACKGROUND OF THE INVENTION

### Field of the Invention

The present disclosure relates to a software updating system, a software updating device, a software updating method, and a storage medium.

### Description of the Related Art

In JP 2022-180041 A, a vehicle electronic control system is disclosed. Such a vehicle electronic control system is a system in which software is installed in an electronic control unit that is capable of being updated in an OTA (Over the Air) manner.

### SUMMARY OF THE INVENTION

There is a long awaited need for a more satisfactory software updating system, a more satisfactory software updating device, a more satisfactory software updating method, and a storage medium in which there is stored a program for causing a computer to execute a more satisfactory software updating method.

The present disclosure has the object of overcoming and solving the aforementioned problem.

A first aspect of the present disclosure is characterized by a software updating system comprising a vehicle, and a server device configured to be capable of communicating with the vehicle via a network, the software updating system comprising an approval confirmation unit configured to carry out a confirmation process to confirm with a user whether or not the user approves the execution of a software updating process with respect to an electronic control unit that is provided in the vehicle, and an update processing unit configured to execute the software updating process in the case that the execution of the software updating process is approved by the user, in the case that the vehicle is equipped with a shift-by-wire system configured to automatically shift a shift position to the parking position, wherein the approval confirmation unit carries out the confirmation process at a time when a first predetermined condition is satisfied, and in the case that the vehicle is not equipped with the shift-by-wire system, the approval confirmation unit carries out the confirmation process at a time when a second predetermined condition that differs from the first predetermined condition is satisfied.

A second aspect of the present disclosure is characterized by a software updating system comprising a vehicle in which there is installed a shift-by-wire system configured to automatically switch a shift position to a parking position, and a server device configured to be capable of communicating with the vehicle via a network, the software updating system comprising a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating, an approval confirmation unit configured to carry out, in the case that a predetermined condition is satisfied at a predetermined timing, a confirmation process to confirm with a user whether or not the user approves the execution of a software updating process with respect to an electronic control unit that is provided in the vehicle, and an update processing unit configured to execute the software updating process in the case that the execution of the software updating process is approved by the user, wherein the predetermined timing is a timing at which the power mode transitions to the third mode.

A third aspect of the present disclosure is characterized by a software updating system comprising a vehicle in which there is installed a shift-by-wire system configured to automatically switch a shift position to a parking position, and a server device configured to be capable of communicating with the vehicle via a network, the software updating system comprising a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating, an approval confirmation unit configured to carry out, in the case that a predetermined condition is satisfied, a confirmation process to confirm with a user whether or not the user approves the execution of a software updating process with respect to an electronic control unit that is provided in the vehicle, and an update processing unit configured to execute the software updating process in the case that the execution of the software updating process is approved by the user, wherein the predetermined condition is a condition based on a timing at which the power mode transitions to the third mode.

A fourth aspect of the present disclosure is characterized by a software updating device in the software updating system according to the first aspect, wherein the software updating device comprises the approval confirmation unit and the update processing unit.

A fifth aspect of the present disclosure is characterized by a software updating device in the software updating system according to the second aspect, wherein the software updating device comprises the power switch, the approval confirmation unit, and the update processing unit.

A sixth aspect of the present invention is characterized by a software updating method that carries out a software updating process with respect to an electronic control unit that is provided in a vehicle, the software updating method comprising, in the case that the vehicle is equipped with a shift-by-wire system configured to automatically shift a shift position to the parking position, an approval confirmation step of carrying out a confirmation process to confirm with a user whether or not the user approves the execution of a software updating process with respect to an electronic control unit that is provided in the vehicle at a time when a first predetermined condition is satisfied, and in the case that the vehicle is not equipped with the shift-by-wire system, carrying out the confirmation process at a time when a second predetermined condition that differs from the first predetermined condition is satisfied, and an update processing step of executing the software updating process, in the case that the execution of the software updating process is approved by the user.

A seventh aspect of the present disclosure is characterized by a software updating method that carries out a software updating process with respect to an electronic control unit that is provided in a vehicle in which there is installed a shift-by-wire system configured to automatically switch a shift position to a parking position, wherein the vehicle comprises a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating, an approval confirmation step of carrying out, in the case that a predetermined condition is satisfied at a predetermined timing, a confirmation process to confirm with a user whether or not the user approves the execution of a software updating process with respect to an electronic control unit that is provided in the vehicle, and an update processing step of executing the software updating process in the case that the execution of the software updating process is approved by the user, wherein the predetermined timing is a timing at which the power mode transitions to the third mode.

An eighth aspect of the present disclosure is characterized by a software updating method that carries out a software updating process with respect to an electronic control unit that is provided in a vehicle in which there is installed a shift-by-wire system configured to automatically switch a shift position to a parking position, wherein the vehicle comprises a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating, an approval confirmation step of carrying out, in the case that a predetermined condition is satisfied, a confirmation process to confirm with a user whether or not the user approves the execution of a software updating process with respect to an electronic control unit that is provided in the vehicle, and an update processing step of executing the software updating process in the case that the execution of the software updating process is approved by the user, wherein the predetermined condition is a condition that is based on a timing at which the power mode transitions to the third mode.

A ninth aspect of the present disclosure is characterized by a program that causes a computer to execute the software updating method according to the sixth aspect.

According to the present disclosure, it is possible to provide a more satisfactory software updating system, a more satisfactory software updating device, a more satisfactory software updating method, and a storage medium in which there is stored a program for causing a computer to execute a more satisfactory software updating method.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a software updating system according to one embodiment;

FIG. 2 is a flow diagram of a software updating process according to the one embodiment;

FIG. 3 is a flowchart showing the software updating process carried out by a software updating device according to the one embodiment;

FIG. 4 is a flowchart showing the software updating process carried out by the software updating device according to the one embodiment;

FIG. 5 is a flowchart showing a campaign application process carried out by a server device according to the one embodiment; and

FIG. 6A and FIG. 6B are diagrams providing a description concerning operations of the software updating device in a vehicle according to the one embodiment.

### DETAILED DESCRIPTION OF THE INVENTION

Conventionally, updating of software for an electronic control unit (hereinafter referred to as an ECU) that is mounted in a vehicle has been carried out at a dealer or the like. In recent years, a vehicle that is capable of carrying out updating of software of an ECU by means of an OTA (Over the Air) manner in which wireless communication is used has become available on the market, and in such a vehicle, it is possible to carry out updating of the software of the ECU without having to take the vehicle to a dealer or the like.

In a software updating process performed by means of an OTA manner, in the process of carrying out activation of the software, there are cases in which the ECU may need to be rebooted. Therefore, activation of the software is carried out while the vehicle is parked, and a driving source such as an engine or a drive motor or the like is stopped. In order to prevent the vehicle from moving unexpectedly while the activation of the software is being carried out, as a condition of starting the activation of the software, the shift position of the vehicle must be placed in the parking position (hereinafter, referred to as a P position).

In the period during which application of the software is carried out, a state is brought about in which the drive source is incapable of being started, and the vehicle cannot be driven. The period during which the drive source cannot be started due to the activation of the software is referred to as downtime.

Prior to the activation of the software being started, a confirmation process to confirm with respect to the user whether or not the user is willing to approve the downtime is carried out. In the confirmation process, downtime approval confirmation information is displayed on a display unit such as an in-vehicle infotainment (In-Vehicle Infotainment: hereinafter referred to as IVI) system. In the downtime approval confirmation information, there is included information concerning a name and a version of the software for which activation is carried out, and information requesting the approval of the user with respect to the downtime, and the like. In the case that the approval of the user with respect to the downtime is obtained, the activation of the software is started. After the drive source of the vehicle is stopped, it may be considered that the user will disembark from the vehicle. If the user disembarks from the vehicle prior to the intention of the user with respect to the downtime being indicated, the activation of the software cannot be started. Therefore, after the drive source of the vehicle has been stopped, it is necessary for the confirmation process to be carried out promptly.

Normally, in the case that the drive source of the vehicle is stopped, the user operates a shift lever or the like, and changes the shift position to the P position, and thereafter, the user operates a start/stop switch (Start Stop Switch: hereinafter referred to as SSSW) or the like, and thereby sets a power mode of the vehicle to IG-OFF. When the power mode of the vehicle is set to IG-OFF, the drive source is stopped.

Conventionally, at a timing at which the power mode of the vehicle is transitioned to IG-OFF, in the case that the shift position is the P position, the downtime approval confirmation information is displayed on the display unit. Moreover, at the timing at which the power mode of the vehicle is transitioned to IG-OFF, in the case that the shift position is not the P position, a determination is made that updating of the software is not possible, and the downtime approval confirmation information is not displayed.

In recent years, vehicles that are equipped with a shift by wire (Shift by Wire: hereinafter, referred to as SBW) system are becoming commercially available. In the vehicle that is equipped with such an SBW system, in the case that the user operates the SSSW, and thereby sets the power mode of the vehicle to IG-OFF, at a time when the shift position is not in the P position, the SBW system automatically sets the shift position to the P position.

For this reason, among users of such a vehicle that is equipped with an SBW system, there are many users who do not set the shift position to the P position when the drive source of the vehicle is stopped,. In a vehicle in which such a user has boarded, at a timing at which the power mode of the vehicle has transitioned to IG-OFF, the shift position is often not in the P position. Therefore, a concern arises in that a determination may be made that updating of the software is not possible, thus leading to frequent occurrences in which activation of the software cannot be achieved.

In the present disclosure, even in a vehicle that is equipped with the SBW system, the activation of the software can be carried out satisfactorily.

### Embodiment

A description will be given below with reference to the drawings concerning a software updating system, a software updating device, a software updating method, and a program according to an embodiment. The program (a computer program, computer software) according to the present embodiment may also be referred to as a computer program product. The computer program product is not limited to being a computer program that is recorded on a recording medium, but may also include a computer program that is transmitted, distributed, or downloaded via the Internet or the like.

### Configuration of Software Updating System

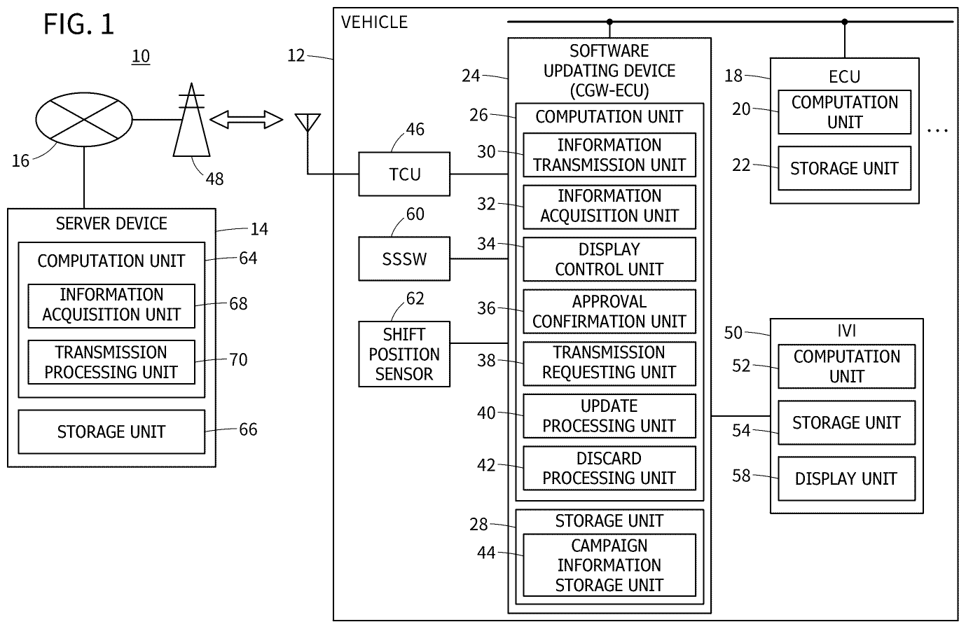

FIG. 1 is a schematic diagram showing a software updating system 10 according to one embodiment. The software updating system 10 comprises a vehicle 12 and a server device 14. The server device 14 is capable of communicating with the vehicle 12 via a network 16.

A plurality of ECUs 18 are mounted in the vehicle 12. Each of the ECUs 18 carries out a control in order to realize a driving function and other functions of the vehicle 12. Each of the ECUs 18 includes a computation unit 20 and a storage unit 22. The computation unit 20, for example, is a processor such as a CPU (Central Processing Unit) or a GPU (Graphics Processing Unit) or the like. At least a portion of the computation unit 20 may be realized by an integrated circuit such as an ASIC (Application Specific Integrated Circuit), an FPGA (Field-Programmable Gate Array), or the like. At least a portion of the computation unit 20 may be realized by an electronic circuit including a discrete device.

The storage unit 22 is a computer readable non-transitory tangible storage medium. The storage unit 22 is constituted by a non-illustrated volatile memory, and a non-illustrated non-volatile memory. The volatile memory, for example, is a RAM (Random Access Memory) or the like. The non-volatile memory, for example, is a ROM (Read Only Memory) or a flash memory or the like. Data and the like are stored, for example, in the volatile memory. A program, a table, a map and the like are stored, for example, in the non-volatile memory. At least a portion of the storage unit 22 may be provided in the aforementioned processor, the aforementioned integrated circuit, or the like. At least a portion of the storage unit 22 may be mounted in a device that is connected with the vehicle 12 by means of the network 16.

The vehicle 12 includes a software updating device 24. The software updating device 24 may be configured, for example, by a CGW-ECU (Central Gateway-Electronic Control Unit). The software updating device 24 includes a computation unit 26 and a storage unit 28. The computation unit 26, for example, is a processor such as a CPU, a GPU, or the like. The computation unit 26 includes an information transmission unit 30, an information acquisition unit 32, a display control unit 34, an approval confirmation unit 36, a transmission requesting unit 38, an update processing unit 40, and a discard processing unit 42. The information transmission unit 30, the information acquisition unit 32, the display control unit 34, the approval confirmation unit 36, the transmission requesting unit 38, the update processing unit 40, and the discard processing unit 42 are realized by executing in the computation unit 26 a program that is stored in the storage unit 28. At least a portion of the information transmission unit 30, the information acquisition unit 32, the display control unit 34, the approval confirmation unit 36, the transmission requesting unit 38, the update processing unit 40, and the discard processing unit 42 may be realized by an integrated circuit such as an ASIC, an FPGA or the like. At least a portion of the information transmission unit 30, the information acquisition unit 32, the display control unit 34, the approval confirmation unit 36, the transmission requesting unit 38, the update processing unit 40, and the discard processing unit 42 may be realized by an electronic circuit including a discrete device.

The storage unit 28 is a computer readable non-transitory tangible storage medium. The storage unit 28 is constituted by a non-illustrated volatile memory, and a non-illustrated non-volatile memory. The volatile memory, for example, is a RAM or the like. The non-volatile memory, for example, is a ROM, a flash memory, or the like. Data and the like are stored, for example, in the volatile memory. A program, a table, a map and the like are stored, for example, in the non-volatile memory. At least a portion of the storage unit 28 may be provided in the aforementioned processor, the aforementioned integrated circuit, or the like. At least a portion of the storage unit 28 may be installed in a device that is connected with the vehicle 12 by means of the network 16. The storage unit 28 includes a campaign information storage unit 44.

The software updating device 24 carries out a software updating process of the ECUs 18. Downloading of the software, installation of the software, and activation of the software are included in the software updating process.

The downloading of the software indicates acquiring updating data that is transmitted from the server device 14 via the network 16, and causing the updating data to be stored in the storage unit 28 of the software updating device 24. The updating data is data that includes, for example, the program of the software after having been updated. An installer or the like may be included in the updating data.

The installation of the software indicates loading the updating data from the storage unit 28 into ROMs of the ECUs 18. The installation of the software may be carried out by an installer. The installation of the software may be carried out by copying the updating data to the ROMs.

The activation of the software indicates a process of authenticating a license of the software that has been installed. During the activation of the software, rewriting of executable files and the like that are used by the software prior to updating thereof may be carried out. When the activation of the software is completed, execution of the software in the ECUs 18 is permitted. The activation may be carried out by the software updating device 24, or may be carried out by each of the ECUs 18.

The information transmission unit 30 transmits various types of information to the server device 14. The information acquisition unit 32 acquires various types of information transmitted from the server device 14. The display control unit 34 controls a later-described IVI 50, and thereby causes later-described campaign information, downtime approval confirmation information, and the like to be displayed on a display unit 58 of the IVI 50. The approval confirmation unit 36 performs a confirmation process with respect to the user to confirm with the user whether or not to execute a software updating process such as downloading of the software, activation of the software, and the like. The transmission requesting unit 38 transmits an updating data request to the server device 14. The updating data request is a signal for the purpose of issuing a request to the server device 14 to transmit the updating data to the software updating device 24. The update processing unit 40 carries out an updating process for downloading of the software, installation of the software, and activation of the software. The discard processing unit 42 carries out a discarding process to discard the acquired campaign information that is stored in the campaign information storage unit 44.

The software updating device 24 and the ECUs 18 are connected by a CAN (Controller Area Network) (registered trademark) connection, and are capable of communicating mutually with each other. Moreover, the communication line that connects the software updating device 24 and the ECUs 18 is not limited to being a CAN connection, but may be an Ethernet (registered trademark) connection, or both a CAN connection and an Ethernet connection may be used. Furthermore, as the communication line, there may be used communication lines of other standards apart from a CAN connection and an Ethernet connection.

The software updating device 24 is capable of communicating, via a telematics control unit (hereinafter referred to as TCU) 46, with a base station 48 that is connected to the network 16 by way of cellular communication. The network 16, for example, is the Internet.

The software updating device 24 is connected to the IVI 50. The IVI 50 includes a computation unit 52 and a storage unit 54. The computation unit 52, for example, is a processor such as a CPU, a GPU, or the like.

The storage unit 54 is a computer readable non-transitory tangible storage medium. The storage unit 54 is constituted by a non-illustrated volatile memory, and a non-illustrated non-volatile memory. The volatile memory, for example, is a RAM or the like. The non-volatile memory, for example, is a ROM, a flash memory, or the like. Data and the like are stored, for example, in the volatile memory. A program, a table, a map and the like are stored, for example, in the non-volatile memory. At least a portion of the storage unit 54 may be provided in the aforementioned processor, the integrated circuit, or the like. At least a portion of the storage unit 54 may be installed in a device that is connected with the vehicle 12 by means of the network 16.

The IVI 50 carries out an action of providing information such as route guidance and road traffic information, as well as entertainment through an audio device, a DVD device, a TV tuner, or the like.

The IVI 50 includes the display unit 58. The display unit 58 is installed on a dashboard or the like of the vehicle 12. The display unit 58 is a touch panel display. The display unit 58, together with providing information with respect to the user in the form of images, text, and the like, accepts operational inputs from the user. The screen of the display unit 58 may be a liquid crystal display, an organic electroluminescence (organic EL) display, or the like, but is not particularly limited to this type of display. The touch panel of the display unit 58 may be a resistive type, a capacitive type, or the like, but is not particularly limited to this type. Instead of the display unit 58 being a touch panel display, a combination of a display device such as a heads-up display and a pointing device such as a motion capture device may be used.

The vehicle 12 is equipped with an SSSW 60. By the user operating the SSSW 60, the power mode of the vehicle 12 is switched. In the case that the vehicle 12 is an engine vehicle, the power mode includes IG-ON, ACC-ON, ACC-OFF, and START. In the case that the vehicle 12 is a hybrid vehicle or an electric vehicle, the power mode includes IG-ON, ACC-ON, ACC-OFF, and READY.

When the power mode is IG-ON, all of the electrical equipment of the vehicle 12 can be used. The power mode IG-ON also corresponds to a first mode of the present invention. When the power mode is ACC-ON, a portion of the electrical equipment such as the audio device or the like can be used. The power mode ACC-ON also corresponds to a second mode of the present invention. When the power mode is ACC-OFF, except for a portion of the electrical equipment such as a keyless entry system or the like, none of the electrical equipment can be used. The power mode ACC-OFF also corresponds to a third mode of the present invention. The number of electrical components that are capable of being used in the power mode ACC-ON is smaller than the number of electrical components that are capable of being used in the power mode IG-ON. The number of electrical components that are capable of being used in the power mode ACC-OFF is smaller than the number of electrical components that are capable of being used in the power mode ACC-ON. Hereinafter, the term ACC-ON may be referred to as IG-OFF.

In the START mode, the starter motor is driven to start the engine. After the engine has been started, the power mode transitions to the IG-ON mode. In the READY mode, the drive motor is capable of being driven, and the vehicle 12 can be driven by the drive motor. At a time when the hybrid vehicle and the electric vehicle are capable of being driven, the power modes are IG-ON, and in addition, READY.

The vehicle 12 is equipped with a shift position sensor 62. The shift position sensor 62 detects the selected shift position. A parking position (P position), a neutral position (N position), a drive position (D position), a reverse position (R position), and the like, are capable of being selected as the shift position.

The server device 14 includes a computation unit 64 and a storage unit 66. The computation unit 64, for example, is a processor such as a CPU, a GPU, or the like. The computation unit 64 includes an information acquisition unit 68 and a transmission processing unit 70. The information acquisition unit 68 and the transmission processing unit 70 are realized by executing in the computation unit 64 a program that is stored in the storage unit 66. At least a portion of the information acquisition unit 68 and the transmission processing unit 70 may be realized by an integrated circuit such as an ASIC, an FPGA, or the like. At least a portion of the information acquisition unit 68 and the transmission processing unit 70 may be realized by an electronic circuit including a discrete device.

The storage unit 66 is a computer readable non-transitory tangible storage medium. The storage unit 66 is constituted by a non-illustrated volatile memory, and a non-illustrated non-volatile memory. The volatile memory, for example, is a RAM or the like. The non-volatile memory, for example, is a ROM, a flash memory, or the like. Data and the like are stored, for example, in the volatile memory. A program, a table, a map and the like are stored, for example, in the non-volatile memory. At least a portion of the storage unit 66 may be provided in the aforementioned processor, the aforementioned integrated circuit, or the like. At least a portion of the storage unit 66 may be installed in a device that is connected with the server device 14 by means of the network 16.

A plurality of the vehicles 12 are registered in the server device 14, and the server device 14 manages an updated state of the software of the ECUs 18 of each of the vehicles 12. The server device 14 provides to each of the vehicles 12 the updating data in order to update the software of the ECUs 18 of each of the vehicles 12.

### Flow of Software Updating Process

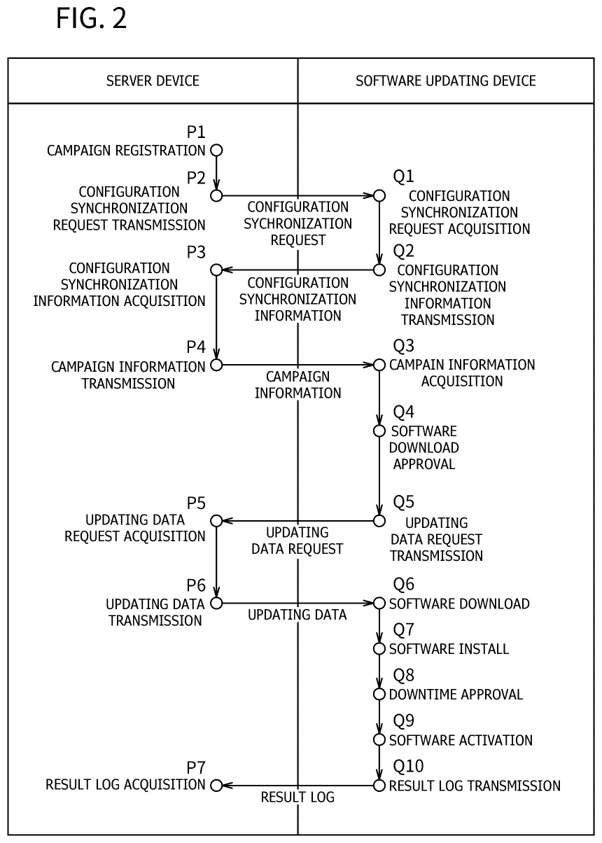

FIG. 2 is a flow diagram of the software updating process according to the one embodiment.

When a campaign is registered in the server device 14 (P1), the transmission processing unit 70 transmits a configuration synchronization request to the software updating device 24 of the vehicle 12 (P2). The campaign information, together with the updating data for updating the software of the ECUs 18, is registered in the server device 14 by the software developer of the ECUs 18, and the maker of the vehicle 12 or the like.

When the information acquisition unit 32 of the software updating device 24 acquires the configuration synchronization request (Q1), the information transmission unit 30 transmits configuration synchronization information to the server device 14 (Q2). Information on a unique identifier assigned to each of the ECUs 18 of the vehicle 12, information on the software version of each of the ECUs 18, and the like are included in the configuration synchronization information.

When the information acquisition unit 68 of the server device 14 acquires the configuration synchronization information (P3), the transmission processing unit 70 transmits campaign information concerning the software updating process of each of the ECUs 18 to the software updating device 24 (P4).

The information acquisition unit 32 of the software updating device 24 acquires the campaign information (Q3), and stores the campaign information in the campaign information storage unit 44. The display control unit 34 causes the campaign information to be displayed on the display unit 58 of the IVI 50. A confirmation process to confirm with the user whether or not to approve the downloading of the software is carried out by the approval confirmation unit 36. In this confirmation process, when the user approves the downloading of the software (Q4), the transmission requesting unit 38 transmits the updating data request to the server device 14 (Q5).

When the information acquisition unit 68 of the server device 14 acquires the updating data request (P5), the transmission processing unit 70 transmits the updating data to the software updating device 24 (P6).

The update processing unit 40 of the software updating device 24 acquires the updating data, and upon causing the updating data to be stored in the storage unit 28, downloads the software (Q6). Thereafter, the update processing unit 40 loads the updating data from the storage unit 28 into the ROMs of the ECUs 18, and thereby installs the software (Q7).

Prior to the activation of the software being started, the approval confirmation unit 36 of the software updating device 24 carries out a confirmation process to confirm with the user whether or not to approve the downtime. In this confirmation process, when the user approves the downtime (Q8), the update processing unit 40 of the software updating device 24 carries out the activation of the software of the ECUs 18 (Q9).

When the activation of the software of the ECUs 18 is completed, the information transmission unit 30 transmits a result log to the server device 14 (Q10). In the result log, there is included Information as to whether or not the updating of the software of the ECUs 18 was successful, the time at which the activation was completed, and the like.

When the information acquisition unit 68 of the server device 14 acquires the result log (P7), the updating of the software comes to an end.

### Software Updating Process

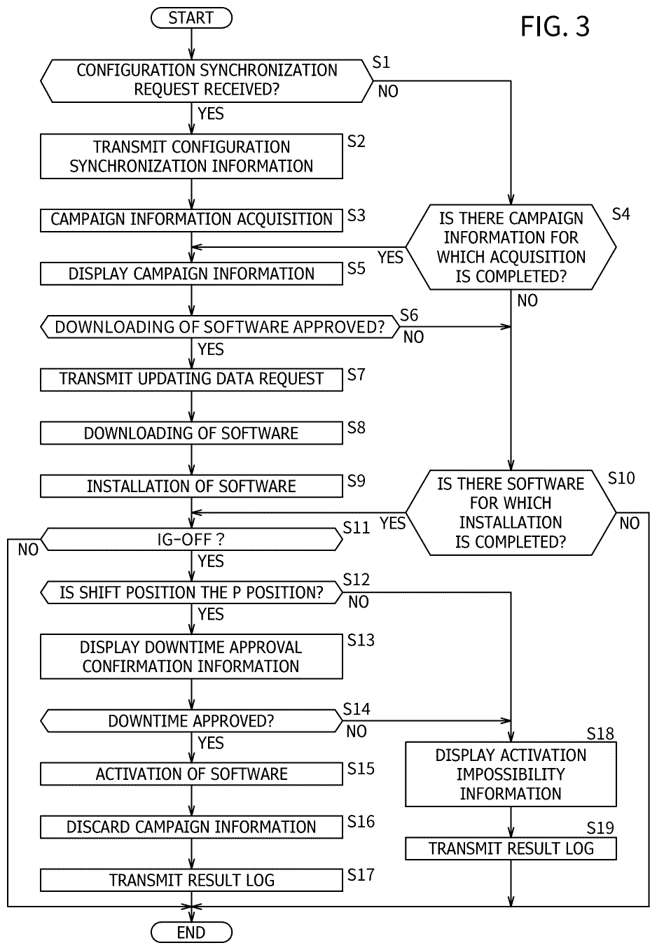

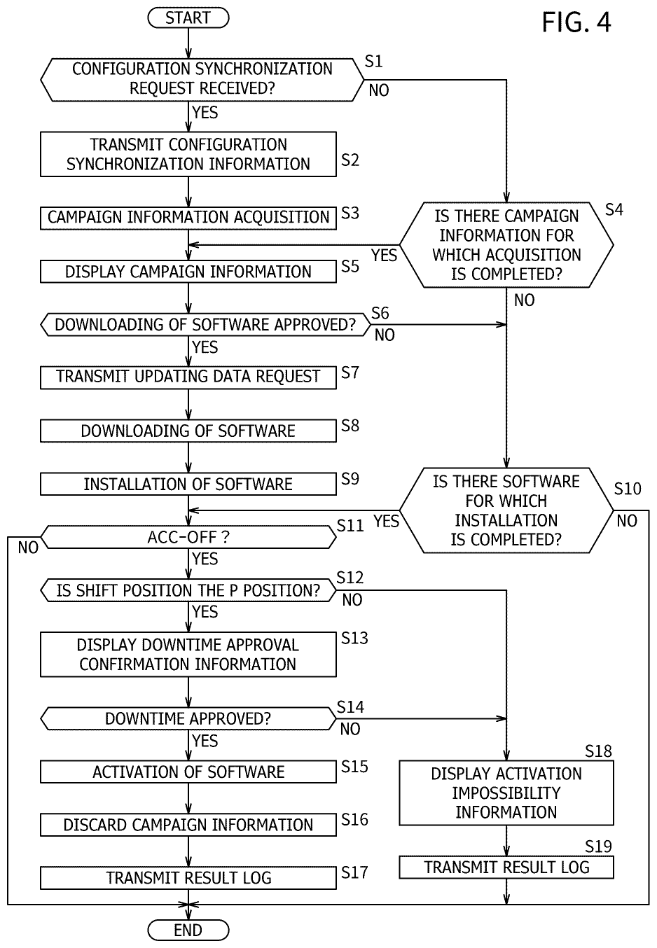

FIG. 3 and FIG. 4 are flowcharts showing the software updating process carried out by the software updating device 24 according to the one embodiment. This process, in the case that the state of the SSSW 60 is IG-ON (or READY), is executed at a predetermined interval.

The software updating process differs in part, depending on whether the vehicle 12 is a vehicle that is not equipped with the SBW system, or is a vehicle that is equipped with the SBW system. In the case that the vehicle 12 is a vehicle that is not equipped with the SBW system, the software updating process of FIG. 3 is executed. On the other hand, in the case that the vehicle 12 is a vehicle that is equipped with the SBW system, the software updating process of FIG. 4 is executed. In the software updating process of FIG. 3 and the software updating process of FIG. 4, the timing at which it is determined whether or not the shift position in step S12 is in the P position differs.

In step S1, the software updating device 24 determines whether or not the configuration synchronization request from the server device 14 has been acquired. In the case that it is determined that the configuration synchronization request has been acquired (step S1: YES), the process transitions to step S2.

In step S2, the information transmission unit 30 of the software updating device 24 transmits the configuration synchronization information to the server device 14. Thereafter, the process transitions to step S3.

In step S3, the information acquisition unit 32 of the software updating device 24 acquires the campaign information. Thereafter, the process transitions to step S5.

In the aforementioned step S1, in the case that it is determined that the configuration synchronization request has not been acquired (step S1: NO), the process transitions to step S4. In step S4, the software updating device 24 determines whether or not there is the campaign information that has been acquired in the campaign information storage unit 44. In the case that it is determined that there is the campaign information that has been acquired in the campaign information storage unit 44 (step S4: YES), the process transitions to step S5.

In step S5, the display control unit 34 of the software updating device 24 causes the campaign information to be displayed on the display unit 58 of the IVI 50. Thereafter, the process transitions to step S6.

In step S6, the approval confirmation unit 36 of the software updating device 24 determines whether or not the downloading of the software has been approved by the user. In the case that the downloading of the software has been approved, the process transitions to step S7.

In step S7, the transmission requesting unit 38 of the software updating device 24 transmits the updating data request to the server device 14. Thereafter, the process transitions to step S8.

In step S8, the update processing unit 40 of the software updating device 24 downloads the software. Thereafter, the process transitions to step S9.

In step S9, the update processing unit 40 of the software updating device 24 installs the software. Thereafter, the process transitions to step S11.

In the aforementioned step S4, in the case it is determined that there is no acquired campaign in the campaign information storage unit 44 (step S4: NO), or alternatively, in the case it is determined in the aforementioned step S6 that the downloading of the software has been refused (step S6: NO), the process transitions to step S10. In step S10, the update processing unit 40 of the software updating device 24 determines whether or not there is any software the installation of which is completed. In the case it is determined that there is software the installation of which is completed (step S10: YES), the process transitions to step S11. In the case it is determined that there is not software the installation of which is completed (step S10: NO), the software updating process comes to an end.

In the case that the vehicle 12 is a vehicle that is not equipped with the SBW system (FIG. 3), then in step S11, the update processing unit 40 of the software updating device 24 determines whether or not the power mode of the vehicle 12 is IG-OFF. In the case that it is determined that the power mode is IG-OFF (step S11: YES), the process transitions to step S12. In the case it is determined that the power mode is not IG-OFF (step S11: NO), the software updating process comes to an end.

In the case that the vehicle 12 is a vehicle that is equipped with the SBW system (FIG. 4), then in step S11, the update processing unit 40 of the software updating device 24 determines whether or not the power mode of the vehicle 12 is ACC-OFF. In the case that it is determined that the power mode is ACC-OFF (step S11: YES), the process transitions to step S12. In the case that it is determined that the power mode is not ACC-OFF (step S11: NO), the software updating process comes to an end.

In step S12, the update processing unit 40 of the software updating device 24 determines whether or not the shift position is the P position. In the case that it is determined that the shift position is the P position (step S12: YES), the process transitions to step S13.

In step S13, the display control unit 34 of the software updating device 24 causes the downtime approval confirmation information to be displayed on the display unit 58 of the IVI 50. Thereafter, the process transitions to step S14.

In step S14, the approval confirmation unit 36 of the software updating device 24 determines whether or not the downtime has been approved by the user. In the case that it is determined that the downtime has been approved (step S14: YES), the process transitions to step S15.

In step S15, the update processing unit 40 of the software updating device 24 carries out the activation of the software. Thereafter, the process transitions to step S16.

In step S16, the discard processing unit 42 of the software updating device 24 discards the campaign information that is stored in the campaign information storage unit 44.

In step S17, the update processing unit 40 of the software updating device 24 creates a result log indicating that the updating of the software was successful, and the information transmission unit 30 transmits the result log that was created to the server device 14. Thereafter, the software updating process comes to an end.

In the aforementioned step S12, in the case it is determined that the shift position is not the P position (step S12: NO), or alternatively, in the aforementioned step S14, in the case it is determined that the downtime has been refused (step S14: NO), the process transitions to step S18. In step S18, the display control unit 34 of the software updating device 24 causes update impossible information indicating that the updating of the software is impossible to be displayed on the display unit 58. Thereafter, the process transitions to step S19.

In step S19, the update processing unit 40 of the software updating device 24 creates a result log indicating that the updating of the software was unsuccessful, and the information transmission unit 30 transmits the result log that was created to the server device 14. Thereafter, the software updating process comes to an end.

### Campaign Application Process

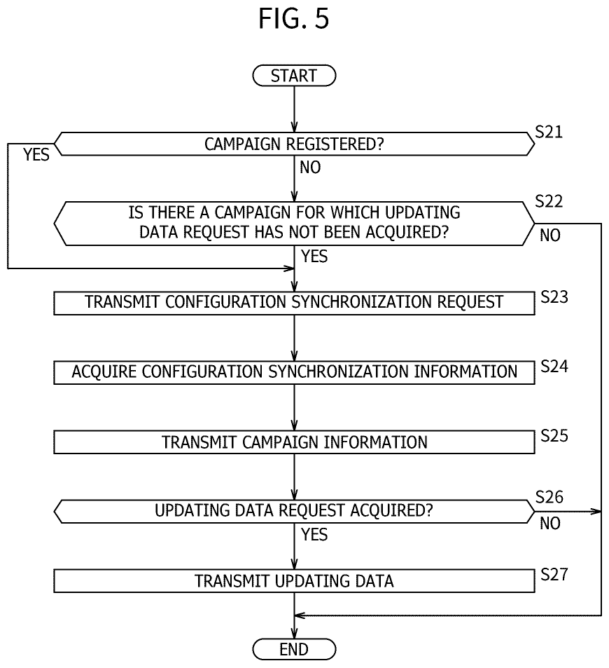

FIG. 5 is a flowchart showing a campaign application process carried out by the server device 14 according to the one embodiment. This process is executed at a predetermined interval.

In step S21, the server device 14 determines whether or not the campaign has been registered. In the case it is determined that the campaign has been registered (step S21: YES), the process transitions to step S23.

In the case it is determined that the campaign has not been registered (step S21: NO), the process transitions to step S22. In step S22, the server device 14 determines whether or not there is a campaign for which the updating data request has not yet been acquired. In the case it is determined that there is a campaign for which the updating data request has not yet been acquired (step S22: YES), the process transitions to step S23. In the case it is determined that there is not a campaign for which the updating data request has not yet been acquired (step S22: NO), the campaign application process comes to an end.

In step S23, the transmission processing unit 70 of the server device 14 transmits the configuration synchronization request to the vehicle 12. Thereafter, the process transitions to step S24.

In step S24, the information acquisition unit 68 of the server device 14 acquires the configuration synchronization information from the vehicle 12. Thereafter, the process transitions to step S25.

In step S25, the transmission processing unit 70 of the server device 14 transmits the campaign information to the vehicle 12. Thereafter, the process transitions to step S26.

In step S26, the server device 14 determines whether or not the updating data request has been acquired. In the case it is determined that the updating data request has been acquired (step S26: YES), the process transitions to step S27. In the case it is determined that the updating data request has not been acquired (step S26: NO), the campaign application process comes to an end.

In step S27, the transmission processing unit 70 of the server device 14 transmits the updating data to the vehicle 12. Thereafter, the campaign application process comes to an end.

### Concerning the Operations of the Software Updating Device

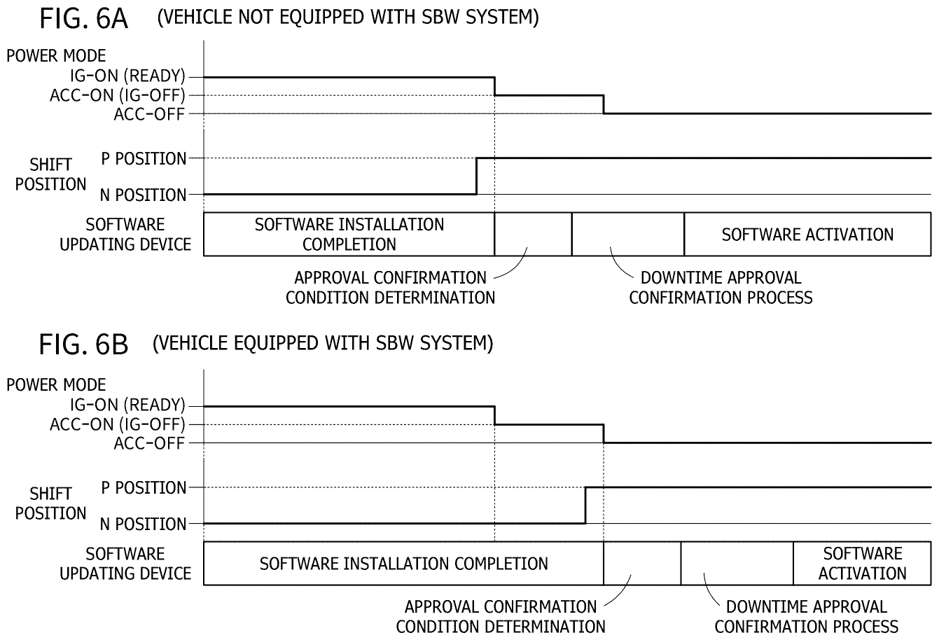

FIG. 6A and FIG. 6B are diagrams providing a description concerning the operations of the software updating device 24 in the vehicle 12 according to the one embodiment. FIG. 6A shows the operations of the software updating device 24 in a vehicle that is not equipped with the SBW system. FIG. 6B shows the operations of the software updating device 24 in a vehicle that is equipped with the SBW system.

In the software updating device 24 according to the one embodiment, a confirmation process (hereinafter, referred to as a downtime approval confirmation process) is executed in the approval confirmation unit 36 to confirm with the user whether or not the downtime is approved prior to the activation of the software. By the user approving the downtime, a state is brought about in which the user also approves the activation of the software.

In the software updating device 24 in the vehicle that is equipped with the SBW system, the approval confirmation unit 36 carries out the downtime approval confirmation process in the case that a first predetermined condition is satisfied. The first predetermined condition is that the shift position is the P position at a timing at which the power mode has transitioned to ACC-OFF.

Stated otherwise, in the software updating device 24 in the vehicle that is equipped with the SBW system, the approval confirmation unit 36 carries out the downtime approval confirmation process in the case that the first predetermined condition is satisfied at a first predetermined timing. The first predetermined timing is a timing at which the power mode has transitioned to ACC-OFF, and the predetermined condition is that the shift position is the P position.

On the other hand, in the software updating device 24 in the vehicle that is not equipped with the SBW system, the approval confirmation unit 36 carries out the downtime approval confirmation process in the case that a second predetermined condition is satisfied. The second predetermined condition is that the shift position is the P position at a timing at which the power mode has transitioned to IG-OFF.

Stated otherwise, in the software updating device 24 in the vehicle that is not equipped with the SBW system, the approval confirmation unit 36 carries out the downtime approval confirmation process in the case that the predetermined condition is satisfied at a second predetermined timing. The second predetermined timing is a timing at which the power mode has transitioned to IG-OFF, and the predetermined condition is that the shift position is the P position.

As shown in FIG. 6B, in a vehicle that is equipped with the SBW system, at a time when the power mode of the vehicle 12 has transitioned to IG-OFF, in the case that the shift position is a position other than the P position (for example, the N position), the SBW system automatically switches the shift position to the P position. After the shift position is switched to the P position, the power mode of the vehicle 12 transitions to ACC-OFF.

For this reason, among users of the vehicle 12 that is equipped with the SBW system, when the drive source of the vehicle 12 is stopped, there are many users who do not set the shift position to the P position. Provisionally, in the case that the condition for carrying out the downtime approval confirmation process in a vehicle that is equipped with the SBW system is set to the same condition as the condition for carrying out the downtime approval confirmation process in a vehicle that is not equipped with the SBW system, in the vehicle that is equipped with the SBW system, there is a concern that it may be determined that updating of the software is not possible, and that a situation in which activation of the software is not carried out may occur frequently.

In the present disclosure, the condition for carrying out the downtime approval confirmation process in a vehicle that is equipped with the SBW system is made different from the condition for carrying out the downtime approval confirmation process in a vehicle that is not equipped with the SBW system. Specifically, the condition for carrying out the downtime approval confirmation process in a vehicle that is not equipped with the SBW system is that the shift position is the P position at the timing at which the power mode has transitioned to IG-OFF. In contrast thereto, the condition for carrying out the downtime approval confirmation process in a vehicle that is equipped with the SBW system is that the shift position is the P position at the timing at which the power mode has transitioned to ACC-OFF. In accordance with this feature, even in a vehicle that is equipped with the SBW system, the number of cases in which it is determined that updating of the software is not possible decrease, and the activation of the software can be satisfactorily carried out.

Concerning the above-described embodiment, the following supplementary notes are further disclosed.

### Supplementary Note 1

The software updating system (10) according to the present disclosure comprises the vehicle (12), and the server device (14) that is capable of communicating with the vehicle via the network (16), the software updating system comprising the approval confirmation unit (36) configured to carry out the confirmation process to confirm with the user whether or not the user approves the execution of the software updating process with respect to the electronic control unit that is provided in the vehicle, and the update processing unit (40) configured to execute the software updating process in the case that the execution of the software updating process is approved by the user, in the case that the vehicle is equipped with the shift-by-wire system that automatically shifts the shift position to the parking position, wherein the approval confirmation unit carries out the confirmation process at the time when the first predetermined condition is satisfied, and in the case that the vehicle is not equipped with the shift-by-wire system, the approval confirmation unit carries out the confirmation process at the time when the second predetermined condition that differs from the first predetermined condition is satisfied. In accordance with such a configuration, even in a vehicle that is equipped with the SBW system, the activation of the software can be carried out satisfactorily.

### Supplementary Note 2

In the software updating system according to Supplementary Note 1, the software updating system may be further equipped with the power mode switch that is capable of switching the power mode of the vehicle based on the operation made by the user to at least one of the first mode in which the first number of electrical components from among the plurality of electrical components that are mounted on the vehicle are capable of operating, the second mode in which the second number of electrical components that is smaller than the first number are capable of operating, and the third mode in which the third number of electrical components that is smaller than the second number are capable of operating, wherein the first predetermined condition may be that the shift position is the parking position at the timing at which the power mode transitions to the third mode, and the second predetermined condition may be that the shift position is the parking position at the timing at which the power mode transitions to the second mode.

### Supplementary Note 3

The software updating system of the present disclosure comprises the vehicle in which there is installed the shift-by-wire system that automatically switches the shift position to the parking position, and the server device that is capable of communicating with the vehicle via the network, the software updating system comprising the power mode switch that is capable of switching the power mode of the vehicle based on the operation made by the user to at least one of the first mode in which the first number of electrical components from among the plurality of electrical components mounted on the vehicle are capable of operating, the second mode in which the second number of electrical components that is smaller than the first number are capable of operating, and the third mode in which the third number of electrical components that is smaller than the second number are capable of operating, the approval confirmation unit that carries out, in the case that the predetermined condition is satisfied at the predetermined timing, the confirmation process to confirm with the user whether or not the user approves the execution of the software updating process with respect to the electronic control unit that is provided in the vehicle, and the update processing unit that executes the software updating process in the case that the execution of the software updating process has been approved by the user, wherein the predetermined timing is the timing at which the power mode transitions to the third mode.

### Supplementary Note 4

In the software updating system according to Supplementary Note 3, the predetermined condition may be that the shift position is the parking position.

### Supplementary Note 5

The software updating system of the present disclosure comprises the vehicle in which there is installed the shift-by-wire system that automatically switches the shift position to the parking position, and the server device that is capable of communicating with the vehicle via the network, the software updating system comprising the power mode switch that is capable of switching the power mode of the vehicle based on the operation made by the user to at least one of the first mode in which the first number of electrical components from among the plurality of electrical components mounted on the vehicle are capable of operating, the second mode in which the second number of electrical components that is smaller than the first number are capable of operating, and the third mode in which the third number of electrical components that is smaller than the second number are capable of operating, the approval confirmation unit that carries out, in the case that the predetermined condition is satisfied, the confirmation process to confirm with the user whether or not the user approves the execution of the software updating process with respect to the electronic control unit that is provided in the vehicle, and the update processing unit that executes the software updating process in the case that the execution of the software updating process is approved by the user, wherein the predetermined condition is the condition based on the timing at which the power mode transitions to the third mode.

### Supplementary Note 6

In the software updating system according to Supplementary Note 5, the predetermined condition may be that the shift position is the parking position at the timing at which the power mode transitions to the third mode.

### Supplementary Note 7

The software updating device (24) according to the present disclosure is the software updating device in the software updating system described according to Supplementary Note 1 or 2, and comprises the approval confirmation unit and the update processing unit.

### Supplementary Note 8

The software updating device according to the present disclosure is the software updating device in the software updating system according to any one of Supplementary Notes 3 to 6, and comprises the power mode switch, the approval confirmation unit, and the update processing unit.

### Supplementary Note 9

The software updating method according to the present disclosure is the software updating method that carries out a software updating process with respect to an electronic control unit that is provided in a vehicle, the software updating method comprising, in the case that the vehicle is equipped with a shift-by-wire system configured to automatically shift a shift position to the parking position, an approval confirmation step of carrying out a confirmation process to confirm with a user whether or not the user approves the execution of a software updating process with respect to an electronic control unit that is provided in the vehicle at a time when a first predetermined condition is satisfied, and in the case that the vehicle is not equipped with the shift-by-wire system, carrying out the confirmation process at a time when a second predetermined condition that differs from the first predetermined condition is satisfied, and an update processing step of executing the software updating process, in the case that the execution of the software updating process is approved by the user.

### Supplementary Note 10

In the software updating method according to Supplementary Note 9, the vehicle may be equipped with the power mode switch that is capable of switching the power mode of the vehicle based on the operation made by the user to at least one of the first mode in which the first number of electrical components from among the plurality of electrical components that are mounted on the vehicle are capable of operating, the second mode in which the second number of electrical components that is smaller than the first number are capable of operating, and the third mode in which the third number of electrical components that is smaller than the second number are capable of operating, the first predetermined condition may be that the shift position is the parking position at the timing at which the power mode transitions to the third mode, and the second predetermined condition may be that the shift position is the parking position at the timing at which the power mode transitions to the second mode.

### Supplementary Note 11

The software updating method according to the present disclosure is the software updating method that carries out the software updating process with respect to the electronic control unit that is provided in the vehicle in which there is installed the shift-by-wire system that automatically switches the shift position to the parking position, wherein the vehicle comprises the power mode switch that is capable of switching the power mode of the vehicle based on the operation made by the user to at least one of the first mode in which the first number of electrical components from among a plurality of electrical components that are mounted on the vehicle are capable of operating, the second mode in which the second number of electrical components that is smaller than the first number are capable of operating, and the third mode in which the third number of electrical components that is smaller than the second number are capable of operating, the approval confirmation step of carrying out, in the case that the predetermined condition is satisfied at the predetermined timing, the confirmation process to confirm with the user whether or not the user approves the execution of the software updating process with respect to the electronic control unit that is provided in the vehicle, and the update processing step of executing the software updating process in the case that the execution of the software updating process is approved by the user, wherein the predetermined timing is the timing at which the power mode transitions to the third mode.

### Supplementary Note 12

Concerning the software updating method according to the present disclosure, in the software updating method according to Supplementary Note 11, the predetermined condition may be that the shift position is the parking position.

### Supplementary Note 13

The software updating method according to the present disclosure is the software updating method that carries out the software updating process with respect to the electronic control unit that is provided in the vehicle in which there is installed the shift-by-wire system that automatically switches the shift position to the parking position, wherein the vehicle comprises the power mode switch that is capable of switching the power mode of the vehicle based on the operation made by the user to at least one of the first mode in which the first number of electrical components from among a plurality of electrical components that are mounted on the vehicle are capable of operating, the second mode in which the second number of electrical components that is smaller than the first number are capable of operating, and the third mode in which the third number of electrical components that is smaller than the second number are capable of operating, the approval confirmation step of carrying out, in the case that the predetermined condition is satisfied, the confirmation process to confirm with the user whether or not the user approves the execution of the software updating process with respect to the electronic control unit that is provided in the vehicle, and the update processing step of executing the software updating process in the case that the execution of the software updating process is approved by the user, wherein the predetermined condition is the condition that is based on the timing at which the power mode transitions to the third mode.

### Supplementary Note 14

In the software updating method according to Supplementary Note 13, the predetermined condition may be that the shift position is the parking position at the timing at which the power mode transitions to the third mode.

### Supplementary Note 15

The program of the present disclosure causes the computer to execute the software updating method according to any one of Supplementary Notes 9 to 14.

Although the present disclosure has been described in detail, the present disclosure is not necessarily limited to the specific embodiments described above. These embodiments can be subjected to various additions, substitutions, modifications, partial deletions and the like, withing a range that does not depart from the essence and gist of the present disclosure, or alternatively, the spirit and gist of the present disclosure as derived from the contents described in the claims and their equivalents. Further, these embodiments can also be implemented in combination. For example, in the above-described embodiments, the order of each of the operations and the order of each of the processes are shown merely as examples, and the present invention is not necessarily limited to these examples. The same applies also in the case that numerical values or mathematical expressions are used in the description of the aforementioned embodiments.

1. A software updating system comprising a vehicle, and a server device configured to be capable of communicating with the vehicle via a network, the software updating system comprising
one or more processors configured to execute computer-executable instructions stored in a memory,
wherein
the one or more processors execute the computer-executable instructions to cause the software updating system to:
in a case that the vehicle is equipped with a shift-by-wire system configured to automatically shift a shift position to a parking position, carry out, at a time when a first predetermined condition is satisfied, a confirmation process to confirm with a user whether or not the user approves execution of a software updating process with respect to an electronic control unit that is provided in the vehicle;
in a case that the vehicle is not equipped with the shift-by-wire system, carry out the confirmation process at a time when a second predetermined condition that differs from the first predetermined condition is satisfied; and
in a case that the execution of the software updating process is approved by the user, execute the software updating process.

2. The software updating system according to claim 1, further comprising a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating,
wherein
the first predetermined condition is that the shift position is the parking position at a timing at which the power mode transitions to the third mode; and
the second predetermined condition is that the shift position is the parking position at a timing at which the power mode transitions to the second mode.

3. A software updating system comprising a vehicle in which there is installed a shift-by-wire system configured to automatically switch a shift position to a parking position, and a server device configured to be capable of communicating with the vehicle via a network, the software updating system comprising:
a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating; and
one or more processors configured to execute computer-executable instructions stored in a memory,
wherein
the one or more processors execute the computer-executable instructions to cause the software updating system to:
in a case that a predetermined condition is satisfied at a timing at which the power mode transitions to the third mode, carry out a confirmation process to confirm with a user whether or not the user approves execution of a software updating process with respect to an electronic control unit that is provided in the vehicle; and
in a case that the execution of the software updating process is approved by the user, executes the software updating process.

4. The software updating system according to claim 3, wherein the predetermined condition is that the shift position is the parking position.

5. A software updating system comprising a vehicle in which there is installed a shift-by-wire system configured to automatically switch a shift position to a parking position, and a server device configured to be capable of communicating with the vehicle via a network, the software updating system comprising:
a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating; and
one or more processors configured to execute computer-executable instructions stored in a memory,
wherein
the one or more processors execute the computer-executable instructions to cause the software updating system to:
in a case that a predetermined condition that is a condition based on a timing at which the power mode transitions to the third mode is satisfied, carry out a confirmation process to confirm with a user whether or not the user approves execution of a software updating process with respect to an electronic control unit that is provided in the vehicle; and
in a case that the execution of the software updating process is approved by the user, execute the software updating process.

6. The software updating system according to claim 5, wherein the predetermined condition is that the shift position is the parking position at a timing at which the power mode transitions to the third mode.

7. A software updating device in the software updating system according to claim 1, the software updating device comprising
one or more processors configured to execute computer-executable instructions stored in a memory,
wherein
the one or more processors execute the computer-executable instructions to cause the software updating device to:
in a case that the vehicle is equipped with a shift-by-wire system configured to automatically shift a shift position to the parking position, carry out, at a time when a first predetermined condition is satisfied, a confirmation process to confirm with a user whether or not the user approves execution of a software updating process with respect to an electronic control unit that is provided in the vehicle;
in the case that the vehicle is not equipped with the shift-by-wire system, carry out the confirmation process at a time when a second predetermined condition that differs from the first predetermined condition is satisfied; and
in a case that the execution of the software updating process is approved by the user, execute the software updating process.

8. The software updating device in the software updating system according to claim 3, the software updating device comprising:
a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating; and
one or more processors configured to execute computer-executable instructions stored in a memory,
wherein
the one or more processors execute the computer-executable instructions to cause the software updating system to:
in a case that a predetermined condition is satisfied at a timing at which the power mode transitions to the third mode, carry out a confirmation process to confirm with a user whether or not the user approves execution of a software updating process with respect to an electronic control unit that is provided in the vehicle; and
in a case that the execution of the software updating process is approved by the user, execute the software updating process.

9. A software updating method that carries out a software updating process with respect to an electronic control unit that is provided in a vehicle, the software updating method comprising:
in a case that the vehicle is equipped with a shift-by-wire system configured to automatically shift a shift position to the parking position, carrying out, at a time when a first predetermined condition is satisfied, a confirmation process to confirm with a user whether or not the user approves execution of a software updating process with respect to an electronic control unit that is provided in the vehicle;
in a case that the vehicle is not equipped with the shift-by-wire system, carrying out the confirmation process at a time when a second predetermined condition that differs from the first predetermined condition is satisfied; and
in a case that the execution of the software updating process is approved by the user, executing the software updating process.

10. The software updating method according to claim 9, wherein the vehicle is equipped with a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating;
the first predetermined condition is that the shift position is the parking position at a timing at which the power mode transitions to the third mode; and
the second predetermined condition is that the shift position is the parking position at a timing at which the power mode transitions to the second mode.

11. A software updating method that carries out a software updating process with respect to an electronic control unit that is provided in a vehicle equipped with a shift-by-wire system configured to automatically shift a shift position to a parking position, wherein
the vehicle comprises a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating,
the software updating method comprising:
in a case that a predetermined condition is satisfied at a timing at which the power mode transitions to the third mode, carrying out a confirmation process to confirm with a user whether or not the user approves execution of a software updating process; and
in a case that the execution of the software updating process is approved by the user, executing the software updating process.

12. The software updating method according to claim 11, wherein the predetermined condition is that the shift position is the parking position.

13. A software updating method that carries out a software updating process with respect to an electronic control unit that is provided in a vehicle equipped with a shift-by-wire system configured to automatically shift a shift position to a parking position, wherein
the vehicle comprises a power mode switch configured to be capable of switching a power mode of the vehicle based on an operation made by a user to at least one of a first mode in which a first number of electrical components from among a plurality of electrical components mounted on the vehicle are capable of operating, a second mode in which a second number of electrical components that is smaller than the first number are capable of operating, and a third mode in which a third number of electrical components that is smaller than the second number are capable of operating,
the software updating method comprising:
in a case that a predetermined condition that is a condition based on a timing at which the power mode transitions to the third mode is satisfied, carrying out a confirmation process to confirm with a user whether or not the user approves execution of a software updating process; and
in a case that the execution of the software updating process is approved by the user, executing the software updating process.

14. The software updating method according to claim 13, wherein the predetermined condition is that the shift position is the parking position at a timing at which the power mode transitions to the third mode.

15. A computer readable non-transitory storage medium storing a program that causes a computer to execute the software updating method according to claim 9.
